(19) United States
(12) Patent Application Publication
(10) Pub. No.: US 2010/0135110 A1
(43) Pub. Date: Jun. 3, 2010

(54) AGITATOR FOR TREATING ORGANIC WASTE

(76) Inventor: Sangdong Kwon, Jinju-shi Kyungnam (KR)

Correspondence Address: IPLA P.A., 3550 WILSHIRE BLVD., 17TH FLOOR, LOS ANGELES, CA, 90010, US

(21) Appl. No.: 12/440,224

(22) PCT Filed: Sep. 10, 2007
(86) PCT No.: PCT/KR07/04378

§ 371 Date: Mar. 5, 2009

(30) Foreign Application Priority Data
Sep. 11, 2006 (KR) 10-2006-0087354

(51) Int. Cl. B01F 7/00

(52) U.S. Cl. 366/331

(57) ABSTRACT

The present invention provides an agitator that uniformly mixes contents in an agitation vessel through rotation. The agitator includes a rotating shaft, a plurality of connecting members, a plurality of agitating blades, and an auxiliary agitating blade. One end of the rotating shaft is connected to a driving unit. Each of the connecting members has a predetermined length, and one ends of the connecting members are fixed to the rotating shaft at different positions in a longitudinal direction of the rotating shaft. The plurality of agitating blades arc fixed to the other ends of the plurality of connecting members, respectively, so as to be inclined downward. The auxiliary agitating blade has the shape of a strip curved at a predetermined angle. One end of the auxiliary agitating blade is fixed to the rotating shaft or the connecting member, and the other end thereof is disposed inside the agitating blade near a lower side of one of the agitating blades with a predetermined distance therebetween.

### TECHNICAL FIELD

The present invention relates to an agitator that allows contents to uniformly circulate in an agitation vessel, and more particularly, to an agitator for treating organic waste that can perform a removal of food waste by not burning the food waste but decomposing the food waste using fermentation thereof or change livestock waste into manure by the fermentation of the livestock waste very short period of time.

### BACKGROUND ART

A method of burying organic waste, particularly, food waste, which is generated from homes or eating houses, in the ground, and a method of recycling food waste as manure by a separate food waste treating apparatus have been considered. If the food waste is buried in the ground, environmental pollution is caused by the burial of the food waste for a long time and a bad smell is generated. Therefore, bad smell control facilities should be provided, and it is difficult to select landfills.

Further, when the food waste is recycled as manure, the food waste generally has undesirable effects on the growth of crops and pollutes the soil because a large amount of salt is contained in the food waste in the case of Korea. For this reason, farmers hardly use the manure made from the food waste. Therefore, there is a demand for a method of removing food waste instead of a method of burying the food waste or changing the food waste into manure.

Furthermore, since being suitable to be changed into manure, livestock waste such as excretion of livestock is used as manure. In this case, a method of quickly changing the livestock waste into manure is required in order to reduce manufacturing cost.

Meanwhile, as for a treating method of agitating organic materials, such as food waste or livestock waste, in an agitation vessel in order to ferment the organic materials, it is the most important that the organic materials are uniformly distributed and circulate in the agitation vessel. Unless the organic materials uniformly circulate, microorganisms supplied to facilitate fermentation do not act well. As a result, a fermentation rate is significantly decreased.

In order to solve the problems of the above-mentioned methods of treating the organic materials, the inventor has proposed an agitator as a device that removes the food waste by not burying or burning the food waste but fermenting the food waste. As shown in FIG. 4, the agitator includes a rotating shaft 121, connecting members 120 fixed to the rotating shaft, three plate-shaped agitating blades 123, 124, and 125 that are fixed to ends of the connecting members 120 and each have the shape of a circular arc, and an auxiliary agitating blade 122 of which one end is fixed to the rotating shaft 121. The auxiliary agitating blade 122 is composed of a member having the shape of a curved strip.

In the agitator, food waste positioned at a central portion of an agitation vessel is pushed to the outer portion thereof by the auxiliary agitating blade 122, and the pushed food waste is scooped up by the agitating blade 125 that is positioned at a lower position. Accordingly, the food waste is moved from the central portion of the agitation vessel to an outer portion thereof, moved from the outer portion thereof to an outer upper portion thereof, and then falls down from the outer upper portion thereof to the central portion thereof. As a result, the food waste uniformly circulates in the agitation vessel.

The above-mentioned structure allows the food waste to uniformly come in contact with oxygen. Further, the above-mentioned structure allows microorganisms, which facilitate the fermentation of the food waste, to act well. As a result, it is possible to remove the food waste.

### DISCLOSURE OF INVENTION

### Technical Problem

However, as shown in FIG. 3A, as the agitating blade is rotated in the agitator, the food waste that is scooped up falls down to an empty space that is formed below the agitating blade during the rotation of the agitating blade. Accordingly, most of the scooped food waste returns to an initial position. For this reason, food waste positioned at the lower portion of the agitation vessel is not smoothly moved to the upper portion thereof, which causes a problem that the removal rate of the food waste is decreased.

Further, the food waste is not smoothly moved to the upper portion of the agitation vessel and placed at the lower portion of the agitation vessel. Therefore, there is a problem that an excessive load is applied to the lowermost agitating blade.

### Technical Solution

The present invention has been made to solve the above-mentioned problems, and it is an object of the present invention to provided an agitator for treating organic waste that allows contents to uniformly circulate in an agitation vessel, thereby performing a removal of food waste by the fermentation of the food waste or changing livestock waste into manure in a short period of time.

In order to achieve the above-mentioned object, an aspect of the present invention provides an agitator that uniformly mixes contents in an agitation vessel through rotation. The agitator includes a rotating shaft, a plurality of connecting members, a plurality of agitating blades, and an auxiliary agitating blade. One end of the rotating shaft is connected to a driving unit. Each of the connecting members has a predetermined length, and one ends of the connecting members are fixed to the rotating shaft at different positions in a longitudinal direction of the rotating shaft. The plurality of agitating blades are fixed to the other ends of the plurality of connecting members, respectively, so as to be inclined downward. The auxiliary agitating blade has the shape of a strip curved at a predetermined angle. One end of the auxiliary agitating blade is fixed to the rotating shaft or the connecting member, and the other end thereof is disposed inside the agitating blade near a lower side of one of the agitating blades with a predetermined distance therebetween. Accordingly, the auxiliary agitating blade pushes the contents, which are pushed from the central portion of the agitation vessel to the outer portion thereof, into a space formed due to the rotation of the agitating blade.

As described above, in the conventional agitator, the food waste, which is scooped up during the rotation of the agitating blade, falls down to an empty space that is formed due to the rotation of the agitating blade. Therefore, the food waste does not smoothly circulate.

In contrast, in the agitator according to the aspect of the present invention, the auxiliary agitating blade has the shape of a strip curved at a predetermined angle, and the other end (free end) of the auxiliary agitating blade is disposed inside the agitating blade near the lower side of agitating blade with a predetermined distance therebetween. Therefore, as shown in FIG. 2, an empty space, which is formed during the rotation of the agitating blade, is immediately filled with a portion of the contents that are pushed from the central portion to the outer portion.

For this reason, as shown in FIG. 3B, the contents scooped up by the agitating blade do not fall down, and can be maintained at an upper portion. Accordingly, the contents smoothly circulate through a central lower portion, an outer lower portion, an outer upper portion, and a central lower portion of the agitation vessel in this order. Therefore, microorganisms come in contact with oxygen well, and a fermentation rate is increased. As a result, it is possible to remove food waste in a very short period of time and to change livestock waste into manure.

Further, when one auxiliary agitating blade is provided, the auxiliary agitating blade may be positioned near the agitating blade that is positioned at the lowermost portion of the agitation vessel. Meanwhile, the number of auxiliary agitating blades may be equal to the number of the agitating blades.

Each of the agitating blades may be formed in various shapes. It is preferable that each of the agitating blades be a plate-shaped member having the shape of a circular arc.

A distance between the other end of the auxiliary agitating blade and the agitating blade may be adjusted in proportion to the amount of contents scooped up by the agitating blade. That is, when the width of the agitating blade is large and a large space is formed, a large distance is maintained therebetween. When the width of the agitating blade is small and a small space is formed, a small distance is maintained therebetween. It is preferable that the distance be equal to or similar to the width of the agitating blade.

The agitator according to the aspect of the present invention may be used for various purposes. In particular, the agitator may be suitable for a food waste treating apparatus that removes food waste by fermenting the food waste, or an apparatus for changing livestock waste into manure.

### ADVANTAGEOUS EFFECTS

As described above, according to the aspect of the present invention, it is possible to allow organic materials to uniformly circulate in the agitation vessel by appropriately setting the positions and shapes of the agitating blades and the auxiliary agitating blade. Therefore, it is possible to maximize the activity of the microorganisms. As a result, it is possible to remove food waste by fermenting the food waste or to change livestock waste into manure in a short period of time.

The agitator according to the aspect of the present invention can remove food waste by gasifying the food waste in a short period of time. For this reason, the agitator can be used as a device for significantly reducing food waste in homes, eating houses, restaurants, and the like.

### BRIEF DESCRIPTION OF THE DRAWINGS

FIG. 1 is a perspective view of an agitator according to an embodiment of the present invention.

FIG. 2 is a view showing the movement of contents while the contents are agitated in the agitator according to the embodiment of the present invention.

FIG. 3A is a view showing the movement of food waste when a conventional agitating blade is rotated.

FIG. 3B is a view showing the movement of food waste when an agitating blade according to the embodiment of the present invention is rotated.

FIG. 4 is a view showing a conventional agitator.

### BEST MODE FOR CARRYING OUT THE INVENTION

A preferred embodiment of the present invention will be described in detail below. However, the embodiment is only illustrative, and may have various modifications within the scope and spirit of the invention. Further, the present invention is not limited to the embodiment.

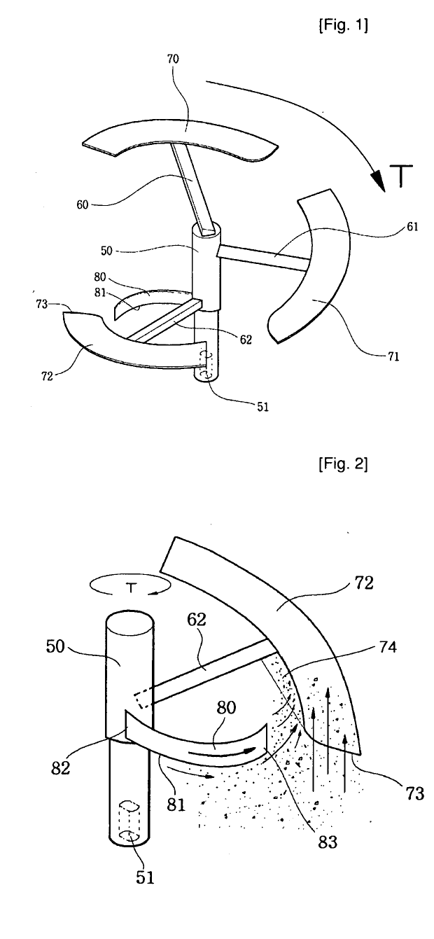

FIG. 1 is a perspective view of an agitator according to an embodiment of the present invention, and FIG. 2 is a view showing the movement of contents while the contents are agitated in the agitator according to the embodiment of the present invention.

As shown in the drawings, an agitator according to the embodiment of the present invention is used to treat food waste. The agitator includes a rotating shaft 50, connecting members 60, 61, and 62, agitating blades 70, 71, and 72, and an auxiliary agitating blade 80.

The rotating shaft 50 is a rod-shaped member that is made of stainless steel and extends in a longitudinal direction. A groove 51 to which a shaft of a drive motor is fitted is formed at the lower portion of the rotating shaft.

Each of the connecting members 60, 61, and 62 is composed of a rod having a triangular cross section. The number of the connecting members is three. One ends of the connecting members are fixed to the rotating shaft at regular intervals in the longitudinal direction of the rotating shaft 50 so that the first, second and third connecting members 60, 61, and 62 are positioned at upper, middle, and lower portions of the rotating shaft, respectively. In this case, the connecting members are fixed to the rotating shaft at intervals of 120°. Therefore, the connecting members are rotated in synchronization with the rotation of the rotating shaft 50. Food waste supplied to an agitation vessel is uniformly distributed in a width direction by the connecting members 60, 61, and 62. If the connecting members 60, 61, and 62 are disposed so that the edges thereof proceed toward the rotational direction, the connecting members serve as cutters. Therefore, it is possible to easily cut food into small pieces, and to reduce the resistance against the rotation.

Each of the agitating blades 70, 71, and 72 is made of stainless steel and has the shape of a plate. The middle portions of the first, second, and third agitating blades 70, 71, and 72 are fixed to the first, second, and third connecting members 60, 61, and 62, respectively. Each of the agitating blades has the shape of a circular arc that corresponds to a predetermined angle range around the central axis of the rotating shaft. Further, each of the agitating blades 70, 71, and 72 is inclined upward or downward at a predetermined angle. Accordingly, when being rotated, the agitating blades can scoop up the contents in the agitation vessel.

As shown in FIG. 2, the auxiliary agitating blade 80 has the shape of a strip that is curved at a predetermined angle so as to be convex toward the rotational direction. One end 82 of the auxiliary agitating blade is fixed to the outer circumferential surface of the rotating shaft 50 in front of the third connecting member 62 in the rotational direction. The other end (free end) 83 thereof is positioned near the lower side 73 of the third agitating blade 72 with a predetermined distance between the other end of the auxiliary agitating blade and the lower side of the third agitating blade. Further, the auxiliary agitating blade 80 is fixed to the rotating shaft so that the lower side 81 of the auxiliary agitating blade is close to the bottom of the agitation vessel. Therefore, during the rotation of the rotating shaft 50, the food waste positioned at the central portion of the agitation vessel is pushed into a space that is formed below the third agitating blade during the rotation of the third agitating blade 72, by the auxiliary agitating blade.

The operation of the agitator, which has the above-mentioned structure, according to the embodiment of the present invention will be described below.

First, a predetermined amount of food waste and sawdust containing microorganism fermenter is supplied to the agitation vessel. While being uniformly distributed by the first, second, and third connecting members 60, 61, and 62, the food waste to be supplied falls down.

Subsequently, when the rotating shaft 50 is rotated, the first, second, and third agitating blades 70, 71, and 72 scoop up the food waste from the lower portion to the upper portion in the agitation vessel because each of the first, second, and third agitating blades is inclined downward.

In this case, the third agitating blade 72, of which lower side is inclined in the rotational direction so as to be close to the bottom of the agitation vessel, scoops up the food waste positioned at the lower portion of the agitation vessel by a height of the blade. The food waste is sent to the lower side of the second agitating blade 71. The second agitating blade is formed at the same angle, and positioned at substantially the same level as the upper side of the third agitating blade 72 or slightly above the upper side of the third agitating blade. Likewise, the second agitating blade 71 scoops up the food waste, and sends the food waste to the lower side of the first agitating blade 70 that is positioned slightly above the upper side of the second agitating blade 71. The food waste passing by the upper side of the first agitating blade 70 falls down to the central portion of the agitation vessel.

Meanwhile, the auxiliary agitating blade 80 fixed to the lower portion of the rotating shaft 50 is curved so as to be convex toward the rotational direction. The free end 83 of the auxiliary agitating blade is disposed near the lower side 73 of the third agitating blade 72 with a distance substantially corresponding to the width of the third agitating blade 72. Therefore, when the rotating shaft 50 is rotated, the food waste positioned at the central portion of the agitation vessel is moved along the auxiliary agitating blade 80 in a direction indicated by an arrow of FIG. 2 and then pushed into an empty space 74 that is formed below the third agitating blade during the rotation of the third agitating blade 72.

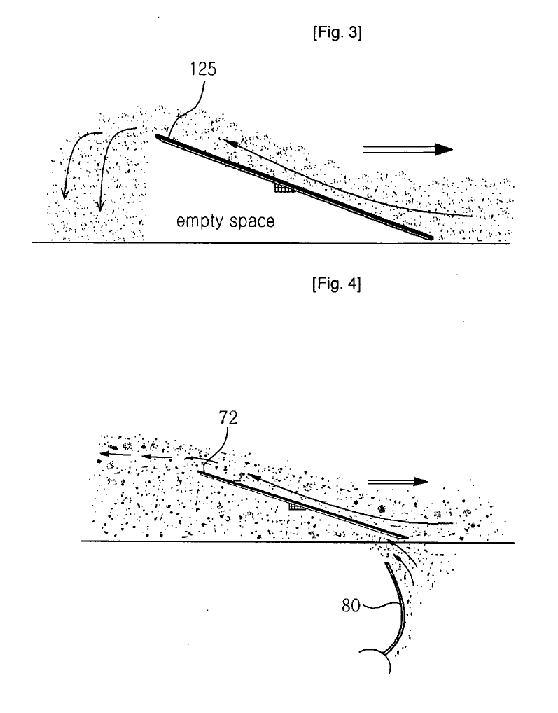

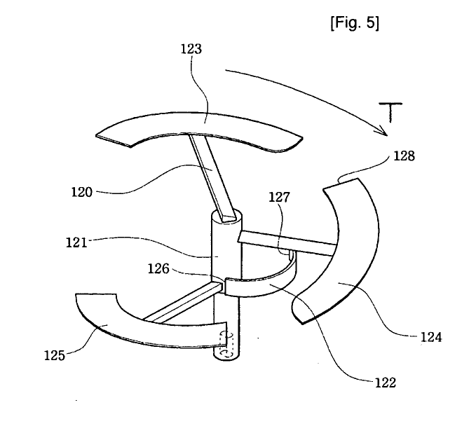

Accordingly, as shown in FIG. 3B, even though the third agitating blade 72 is rotated, the empty space formed therebelow is successively tilled with the food waste. For this reason, it is possible to solve a problem that the food waste scooped up by the third agitating blade 72 falls down, and the food waste can smoothly circulate in a vertical direction.

It was possible to remove 95% or more of the maximum amount of food waste, which is supplied to the agitation vessel, within 24 hours by using a food waste treating apparatus that includes the agitator according to the embodiment of the present invention.

1. An agitator that uniformly mixes contents in an agitation vessel through rotation, comprising:
a rotating shaft of which one end is connected to a driving unit;
a plurality of connecting members of which one ends are fixed to the rotating shaft at different positions in a longitudinal direction of the rotating shaft, each of the connecting members having a predetermined length;
a plurality of agitating blades that are fixed to the other ends of the plurality of connecting members, respectively, so as to be inclined downward; and
an auxiliary agitating blade that has the shape of a strip curved at a predetermined angle, and of which one end is fixed to the rotating shaft or the connecting member and the other end is disposed inside the agitating blade near a lower side of one of the agitating blades with a predetermined distance therebetween, thereby pushing the contents, which are pushed from the central portion of the agitation vessel to the outer portion thereof, into a space formed due to the rotation of the agitating blade.

2. The agitator according to claim 1,
wherein the auxiliary agitating blade is positioned near the agitating blade that is positioned at the lowermost portion of the agitation vessel.

3. The agitator according to claim 1 or 2,
wherein each of the agitating blades is composed a plate-shaped member that has the shape of a circular arc.

4. The agitator according to claim 1 or 2,
wherein the number of auxiliary agitating blades is equal to the number of the agitating blades.

5. The agitator according to claim 1 or 2,
wherein a distance between the other end of the auxiliary agitating blade and the agitating blade is adjusted in proportion to the amount of contents scooped up by the agitating blade.

6. The agitator according to claim 1 or 2,
wherein each of the connecting members has a triangular cross section.

7. The agitator according to claim 1 or 2,
wherein the agitator is used to treat food waste.
